(19) United States
(12) Patent Application Publication
(10) Pub. No.: US 2025/0194459 A1
(43) Pub. Date: Jun. 19, 2025

(54) DECK PLATE SPACING SENSORS AND RELATED DEVICES, SYSTEMS, AND METHODS

(71) Applicant: Ag Leader Technology, Ames, IA (US)

(72) Inventor: Lucas Roe, Ames, IA (US)

(21) Appl. No.: 18/980,728

(22) Filed: Dec. 13, 2024

Related U.S. Application Data
(60) Provisional application No. 63/609,758, filed on Dec. 13, 2023.

(51) Int. Cl. A01D 34/00; A01D 45/02; G01B 7/14

(52) U.S. Cl. CPC A01D 34/006; A01D 45/028; G01B 7/14

(57) ABSTRACT

A deck plate sensing system for a corn harvester having a sensing unit. The sensing unit having a sensor and a magnet associated with a row unit of the corn harvester. The magnet and sensor are configured to measure a distance between the magnet and the magnetic sensor and apply a calibration to determine a relative distance between an adjustable deck plate and a fixed deck plate.

### CROSS-REFERENCE TO RELATED APPLICATION(S)

This application claims the benefit under 35 U.S.C. § 119(e) to U.S. Provisional Application 63/609,758, filed Dec. 13, 2023, and entitled Magnetic Stripper/Deck Plate Sensing System, which is hereby incorporated herein by reference in its entirety for all purposes.

### TECHNICAL FIELD

The disclosure relates to agricultural harvesters, and particularly sensors and systems for use on a corn header.

### BACKGROUND

Various crop harvesters may not include stripper/deck plate spacing sensors. For those crop harvesters that do include prior known stripper/deck plate spacing sensors, the spacing sensors are not highly accurate and have a lot of hysteresis that makes them hard to use for applications that require more precise measurements. These currently existing sensors attach to the deck plate adjuster mechanism which introduces much of the observed hysteresis.

### BRIEF SUMMARY

Disclosed herein are various deck plate sensors and related systems and methods.

In Example 1, a stripper plate sensing system, comprising a magnet and a sensor, wherein the magnet and sensor are configured to detect a relative distance between an adjustable stripper plate and a fixed stripper plate.

Example 2 relates to the stripper plate sensing system of any of Examples 1 and 3-9, wherein the magnet is mounted to the adjustable stripper plate and the sensor is mounted to a row unit frame.

Example 3 relates to the stripper plate sensing system of any of Examples 1-2 and 4-9, wherein the sensor is mounted to the adjustable stripper plate and the magnet is mounted to the row unit frame.

Example 4 relates to the stripper plate sensing system of any of Examples 1-3 and 5-9, wherein the magnet is mounted to the adjustable stripper plate and the sensor is mounted to the fixed stripper plate.

Example 5 relates to the stripper plate sensing system of any of Examples 1-4 and 6-9, wherein the sensor is configured to measure a distance to the magnet and apply a calibration to detect the relative distance between the adjustable stripper plate and the fixed stripper plate.

Example 6 relates to the stripper plate sensing system of any of Examples 1-5 and 7-9, wherein the sensor is in communication with an operations system configured to display and store the relative distance data.

Example 7 relates to the stripper plate sensing system of any of Examples 1-6 and 8-9, wherein the operation system is in communication with a navigation system configured to apply the relative distance data for elimination of cross track error.

Example 8 relates to the stripper plate sensing system of any of Examples 1-7 and 9, wherein the sensor is a hall effect sensor.

Example 9 relates to the stripper plate sensing system of any of Examples 1-8, wherein the sensor is a magnetic sensor.

In Example 10, a deck plate sensing system, comprising a magnet and a magnetic sensor, wherein the magnet and magnetic sensor are configured to measure a distance between the magnet and the magnetic sensor and apply a calibration to measure a relative distance between an adjustable deck plate and a fixed deck plate.

Example 11 relates to the deck plate sensing system of any of Examples 10 and 12-14, wherein the magnet is mounted within a magnet mount, and wherein the magnet mount is affixed to the adjustable deck plate.

Example 12 relates to the deck plate sensing system of any of Examples 10-11 and 13-14, wherein the magnetic sensor is mounted within an enclosure, and wherein the enclosure is affixed to a bracket attached to a row unit frame.

Example 13 relates to the deck plate sensing system of any of Examples 10-12 and 14, wherein the sensor is in communication with an operations system configured to display and store the relative distance data.

Example 14 relates to the deck plate sensing system of any of Examples 10-13, wherein the operations system is in communication with a navigation system configured to apply the relative distance data for elimination of cross track error.

In Example 15, a deck plate sensing system for a corn harvester, comprising a sensing unit comprising magnetic sensor and a magnet associated with a row unit of the corn harvester, wherein the magnet and magnetic sensor are configured to measure a distance between the magnet and the magnetic sensor, and apply a calibration to measure a relative distance between an adjustable deck plate and a fixed deck plate.

Example 16 relates to the deck plate sensing system of any of Examples 15 and 17-20, wherein the magnet is mounted to the adjustable stripper plate and the magnetic sensor is mounted to a row unit frame.

Example 17 relates to the deck plate sensing system of any of Examples 15-16 and 18-20, further comprising a sensing unit in association with each row unit of the corn harvester.

Example 18 relates to the deck plate sensing system of any of Examples 15-17 and 19-20, wherein each magnet is mounted to the adjustable stripper plate and the magnetic sensor is mounted to the row unit frame of its associated row unit.

Example 19 relates to the deck plate sensing system of any of Examples 15-18 and 20, wherein each magnet is mounted to the row unit frame and the magnetic sensor is mounted to the adjustable stripper plate of its associated row unit.

Example 20 relates to the deck plate sensing system of any of Examples 15-19, wherein the sensing unit is in communication with an operations system configured to display and store the relative distance data.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a deck plate sensor installed on a row unit, according to one implementation.

FIG. 2 is a cross-sectional view of a deck plate sensor installed on a row unit, according to one implementation.

FIG. 3 is a cross-sectional view of a deck plate sensor installed on a row unit, according to one implementation.

FIG. 4 is a top view of a magnet mount, according to one implementation.

FIG. 5 is a front view of a sensor and mounting bracket, according to one implementation.

FIG. 6A is a schematic view of the system on a harvester, according to one implementation.

FIG. 6B is a system diagram, according to one implementation.

FIG. 7 shows an exemplary sensor calibration curve.

FIG. 8 shows an exemplary hysteresis analysis.

FIG. 9 shows Table 1 containing experimental data from the system.

### DETAILED DESCRIPTION

Disclosed herein are stripper/deck plate spacing sensors and certain related devices, systems, and methods. The disclosed stripper/deck plate spacing sensors will be referred to herein as a “deck plate sensor” or “deck plate spacing sensor” for ease of reference and clarity but is not intended to be limiting. The disclosed deck plate spacing sensors are configured for sensing spacing of the deck plates in a highly accurate manner with little to no hysteresis. Additionally, the disclosed deck plate sensors may be integrated with various additional systems for use of deck plate spacing measurements by other devices and systems on the harvester or in communication therewith. For example, the deck plate spacing sensor data may be a sensor input to the corn head steering system disclosed in U.S. Pat. No. 11,678,607.

In certain implementations, the described deck plate spacing sensor is able to attach to any corn head with adjustable stripper/deck plates—is universally mountable. In these and other implementations, spacing data may then be available to the machine operator or other electronic devices, as will be described further herein.

In various implementations, the deck plate sensor is attached to all rows of a corn head to monitor stripper/deck plate spacing on all rows. In certain other implementations, the deck plate sensor may be mounted to any single row, or several but not all rows, optionally on corn heads where all stripper/deck plates adjust simultaneously.

In some implementations, the described deck plate sensor mounts directly to the stripper/deck plate and the frame that it adjusts in reference to. Mounting directly to the deck plate results in minimal mechanically induced hysteresis.

In certain implementations, the disclosed deck plate sensor may be integrated with or used in conjunction with an automated/assisted driving system, such as those for eliminating/reducing cross track error. One such system for eliminating cross track error is described in detail in U.S. Pat. No. 11,678,607, which is hereby incorporated by reference in its entirety for all purposes. In these and other implementations, deck plate spacing data is used to accurately calculate cross-track error from stalk data. The herein described deck plate sensor provides accurate data and can be implemented on machines that do not currently have a stripper/deck plate spacing sensor or have inaccurate sensors. That is, the described sensor may be retrofitted onto existing harvesters.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems, and Methods,” U.S. Patent Application 63/626,744, filed Jan. 30, 2024, entitled “Grain Cart Unloading Sensor and Unload Control,” U.S. Patent Application 63/646,038, filed May 13, 2024, entitled “Seed Tube Camera and Related Devices, Systems, and Methods,” U.S. Patent Application 63/646,068, filed May 13, 2024, entitled “Seed Tube Camera and Related Devices, Systems, and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/683,149, filed Aug. 14, 2024, entitled “Seed Tube Camera and Related Devices, Systems, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/723,436, filed Nov. 21, 2024, entitled “Seed Tube Camera and Related Devices, Systems, and Methods,” and U.S. Patent Applicant 63/727,579, filed Dec. 3, 2024, entitled “Smart Shift System for Automatic AB Line Adjustment in Agricultural Operations and Related Devices and Methods,” each of which is incorporated herein by reference.

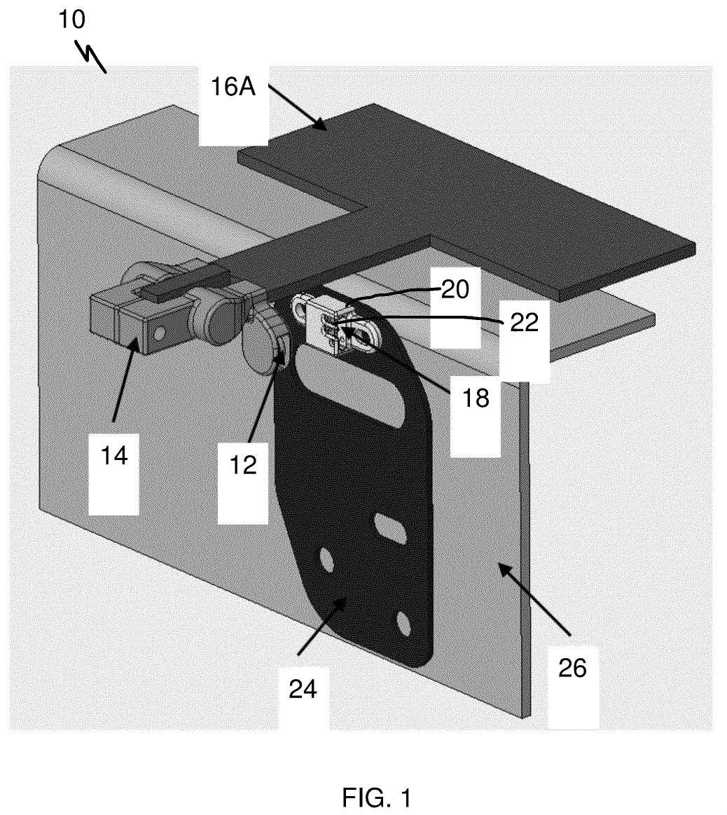

Turning now to the figures in more detail, FIG. 1 shows an exemplary implementation of a space sensing system 10. In various implementations, the system 10 includes a sensing magnet 12 disposed on a magnet mount 14. In various implementations, the sensing magnet 12 and magnet mount 14 are in operational communication with an adjustable stripper/deck plate 16A and a sensor unit 18. The sensor unit 18 may include an enclosure 20 surrounding a sensor electronic board (PCB) 22. The sensor unit 18 may be disposed on a sensor mounting bracket 24. The sensor mounting bracket 24 may be disposed on or otherwise affixed to the row unit frame 26. The sensor mounting bracket 24 may be affixed to the row unit frame 26 by any appreciated mechanism such as fasteners, adhesive, welding, etc.

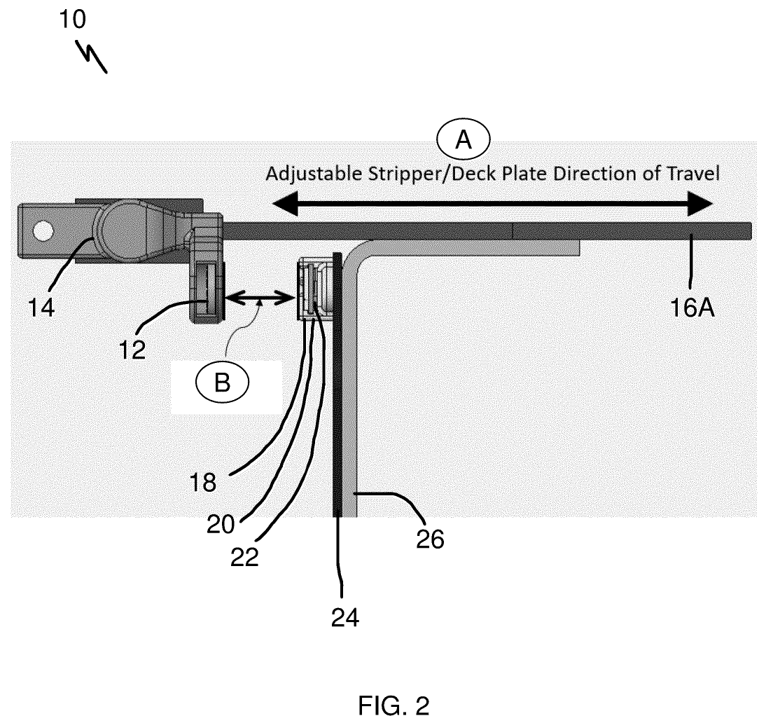

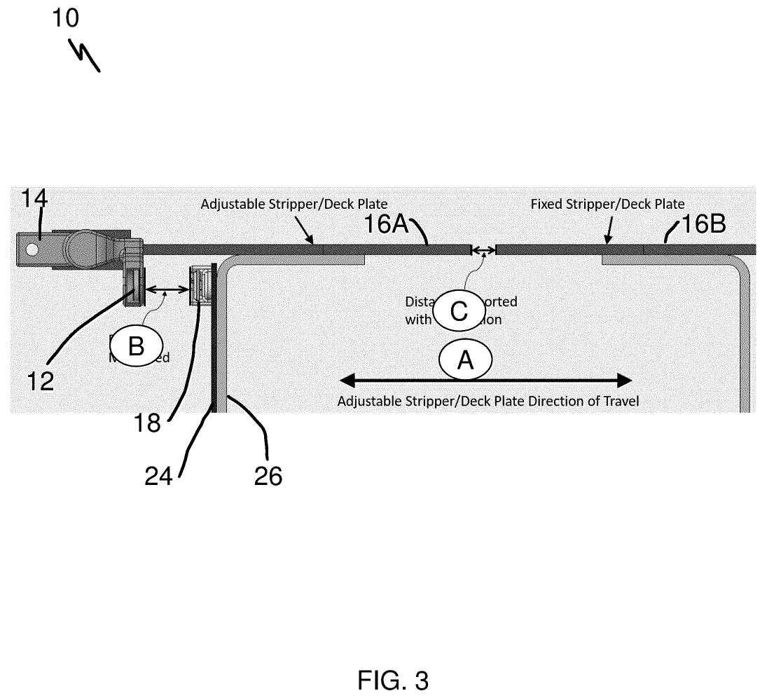

In various implementations of the system 10, the sensor unit 18 is a magnetic or hall effect sensor 18 that detects the magnet 12. Here the sensor 18 detects the distance from the magnet 12 to the sensor 18 (shown at B in FIGS. 2 and 3). This distance may then be used to determine the relative distance between the adjustable stripper/deck plate 16A that the magnet 12 is attached to and the frame 26 that sensor 18 is attached to, as shown in FIGS. 2-3. It would be appreciated that the magnet 12 may be mounted to the frame 26 and the sensor 18 attached to the adjustable stripper/deck plate 16A. Various alternative configurations of components are possible and would be understood and appreciated by those of skill in the art.

The relative measured distance between the adjustable stripper/deck plate 16A and the frame can then be used with a calibration to determine the distance between the adjusting stripper/deck plate 16A and the fixed stripper/deck plate 16B, as shown in FIG. 3. The calibration may include a look up table or other program associating a measured distance (B) with a reported deck plate spacing (C). In some implementations, each row unit on a head that includes a sensor 18 may be individually calibrated.

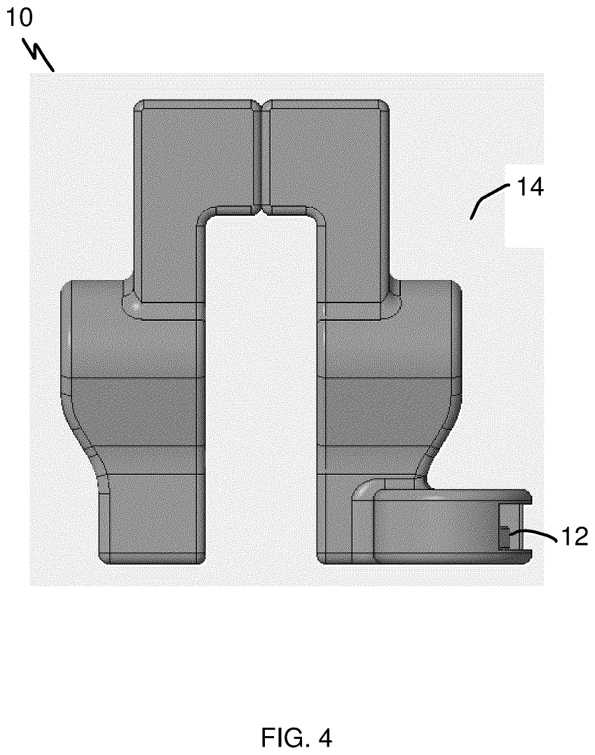

In certain implementations, the magnet 12 is mechanically attached to the deck plate 16A or frame 26 of the row unit. The magnet 12 may optionally be encased in a material 14 that would protect it and rigidly secure it to the deck plate 16A or frame 26. Exemplary materials for the casing 14 include, but are not limited to, plastic, urethane, and aluminum. FIG. 4 shows an exemplary magnet mount 14/casing 14.

In some implementations, the sensor electronic board 22 is mounted in an enclosure 22 to protect the sensor board 22 and mechanically attach it to either the stripper/deck plate 16A or row unit frame 26, as shown in FIGS. 1-3 and 5. Optionally, the sensor 18 and enclosure 22 are mounted to a sensor mounting bracket 24 for mechanical fixation to the row unit frame 26.

The sensing system 10 is operable in varying orientations. These orientations include but are not limited to the magnet 18 mounted to an adjustable stripper/deck plate 16A with the sensor 18 mounted to the row unit frame 26, as seen in FIG. 1. Alternatively, the magnet 12 is mounted to the row unit frame 26 with the sensor unit 18 mounted to the adjustable stripper/deck plate 16A. Alternatively, the magnet 12 is mounted to the fixed stripper/deck plate 16B with the sensor 18 mounted to the adjustable stripper/deck plate 16A. Alternatively, the magnet 12 is mounted to the adjustable stripper/deck plate 16A with the sensor 18 mounted to the fixed stripper/deck plate 16B.

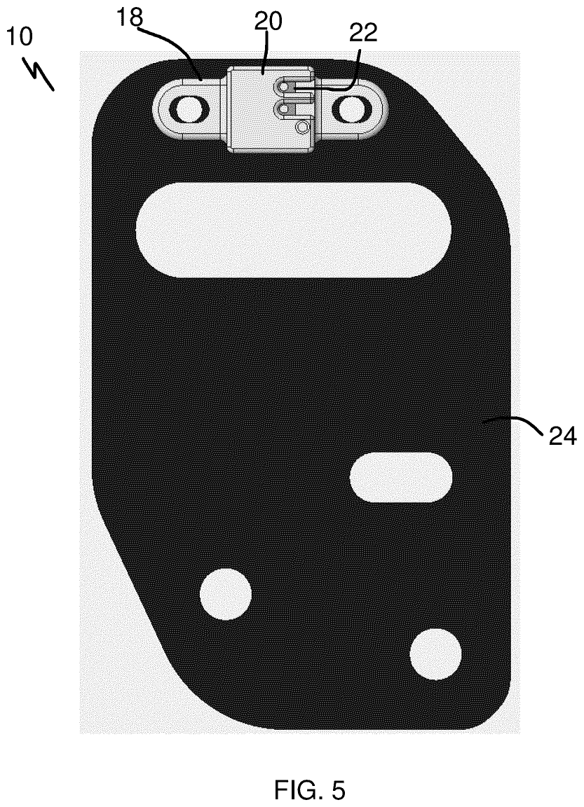

Optionally, as would be understood, the sensor 18 and magnet 12 are swappable, in that the sensor 18 may be affixed within the magnet mount 14 (shown in FIG. 4) while the magnet 12 is affixed within the sensor enclosure 22 (shown in FIG. 5).

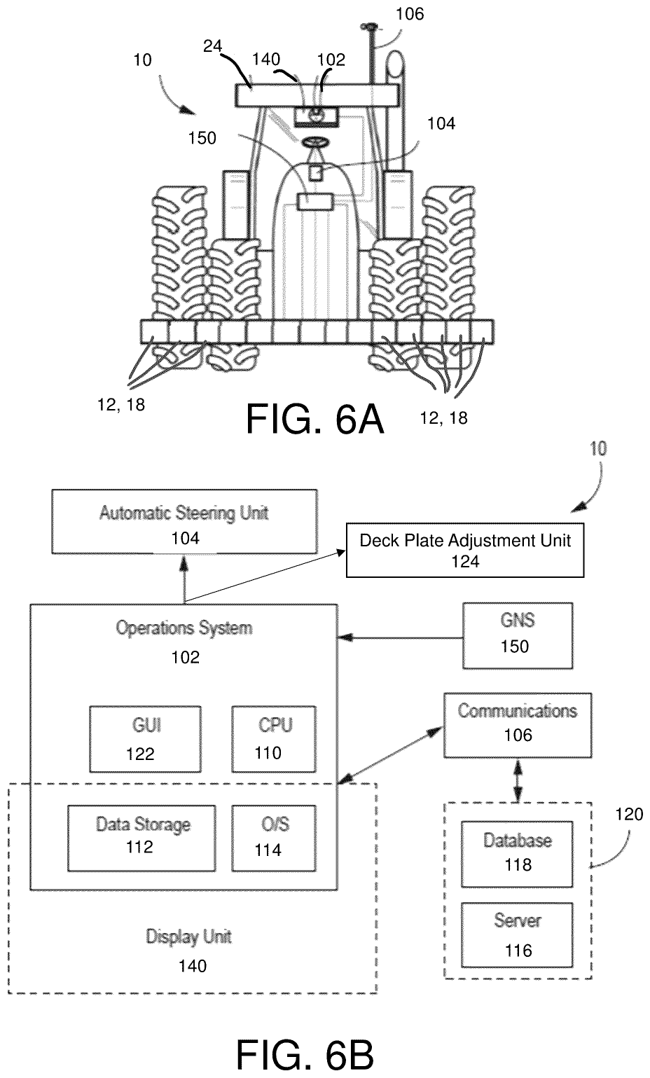

FIGS. 6A and 6B depict exemplary implementations of the space sensing system 100 components fitted to an agricultural vehicle 24, such as a combine harvester 24. It is further understood that the components depicted in FIGS. 6A and 6B are optional, and can be utilized or omitted in the various claimed implementations, and that certain additional components may be required to effectuate the various processes and systems described herein. Such additional components may include hardware, software, firmware, and other electronic components that would be known and appreciated by those of skill in the art.

As shown in FIG. 6A, the space sensing system 10 has an operations system 102 that comprises or is configured to be operationally integrated with a steering unit 104, such as SteerCommand®, a deck plate adjustment unit 124, and an optional communications component 106. The system 10 may be operationally integrated with at least one in-cab display 140, such as an InCommand® display 140, or other suitable display 140 understood in the art. It is appreciated that certain of these displays 140 feature touchscreens, while others are equipped with necessary components for interaction with the various prompts and adjustments discussed herein, such as via a keyboard or other interface.

In various implementations, the system 10 is also operationally integrated with a GNSS or GPS unit 150, such as a GPS 7500, such that the system 10 is configured to input positional data for use in recording data, as would be readily appreciated from the present disclosure.

As shown in FIG. 6B, in various implementations, the operations system 102 is optionally in operational communication with the automatic steering unit 104 or controller 104, the communications component 106, and/or GNSS 150. In certain of these implementations, the operations system 102 is housed in the display 140, though the various components described herein can be housed elsewhere, as would be readily appreciated.

As shown in FIG. 6B, the operations system 102 further has one or more optional processing and computing components, such as a CPU/processor 110, data storage 112, operating system 114, graphical user interface (GUI) 122, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 6B, the communications component 106 is configured for the sending and receiving of data for cloud 120 storage and processing, such as to a remote server 116, database 118, and/or other cloud computing components readily understood in the art. Such connections by the communications component 106 can be made wirelessly via understood internet and/or cellular technologies such as Bluetooth, WiFi, LTE, 3G, 4G, or 5G connections and the like. It is understood that in certain implementations, the communications component 106 and/or cloud 120 components comprise encryption or other data privacy components such as hardware, software, and/or firmware security aspects. In various implementations, the operator or enterprise manager or other third parties are able to receive notifications via their mobile phones or other devices.

The sensor 18, according to certain implementations, is configured to electronically report the data it collects to the operations system 102, shown in FIGS. 6A and 6B. In various implementations the space sensing system 10 interprets the data and sends the stripper/deck plate spacing data to a user interface (such as a graphical user interface 122) for the machine operator to access, as would be appreciated. Along with the machine operator, other electronic modules and devices would be able to access this data and use it for their calculations, algorithms, programs, etc. Optionally, the spacing data is logged and stored in data storage 112. Further, the spacing data may include or be associated with GNS 150 data for spatially logging and visualizing the data.

In various implementations, the operations system 102 receives the sensor raw data then runs it through an algorithm that is calibrated to the sensor 18 to output a calculated distance (C) in the chosen unit of measurement.

As would be understood, magnetic strength follows the B-H curve for magnets and can be modeled with an inverse power law equation. Since magnetic strength follows a curve based on a power law equation, this calculation can be performed with a power law equation such as the equation below:

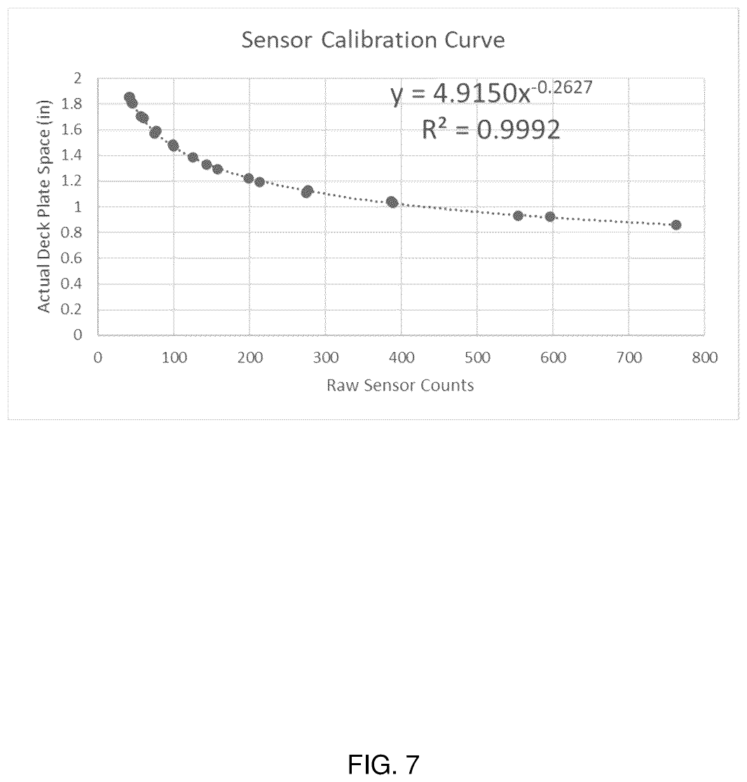

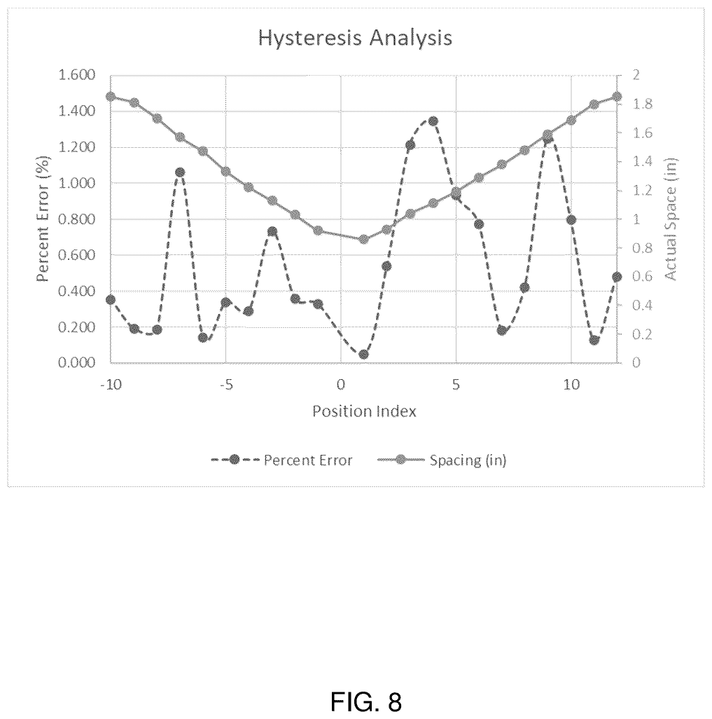

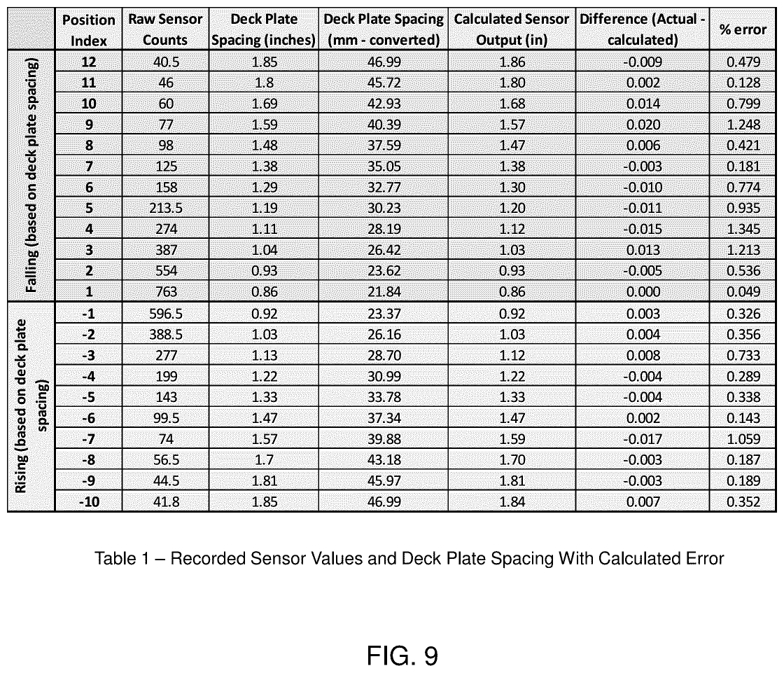

y=C*x^{p}+n

where y is the output distance, C is the coefficient that would be part of the calibration, x is the input sensor value, p is the exponent that is part of the calibration, and n is an optional constant offset value. Further equations can of course be used. Exemplary sensor data, the calibration, and error values can be seen in FIGS. 7-9. FIG. 7 showing an exemplary sensor calibration curve. FIG. 8 showing a hysteresis analysis plot. FIG. 9 showing Table 1 including recorded sensor values and deck plate spacing with calculated error.

FIGS. 7 and 9 show experimental data and the error percentages that the system 10 produces. As can be seen, very low error shows a high accuracy in the system 10. Further no trend can be found in the error data that follows the rising and falling spacing values, as such it is proven that very little, if any, hysteresis exists.

Although the disclosure has been described with references to various embodiments, persons skilled in the art will recognize that changes may be made in form and detail without departing from the spirit and scope of this disclosure.

What is claimed is:

1. A stripper plate sensing system, comprising:
(a) a magnet; and
(b) a sensor,
wherein the magnet and sensor are configured to detect a relative distance between an adjustable stripper plate and a fixed stripper plate.

2. The stripper plate sensing system of claim 1, wherein the magnet is mounted to the adjustable stripper plate and the sensor is mounted to a row unit frame.

3. The stripper plate sensing system of claim 1, wherein the sensor is mounted to the adjustable stripper plate and the magnet is mounted to the row unit frame.

4. The stripper plate sensing system of claim 1, wherein the magnet is mounted to the adjustable stripper plate and the sensor is mounted to the fixed stripper plate.

5. The stripper plate sensing system of claim 1, wherein the sensor is configured to measure a distance to the magnet and apply a calibration to detect the relative distance between the adjustable stripper plate and the fixed stripper plate.

6. The stripper plate sensing system of claim 1, wherein the sensor is in communication with an operations system configured to display and store the relative distance data.

7. The stripper plate sensing system of claim 6, wherein the operation system is in communication with a navigation system configured to apply the relative distance data for elimination of cross track error.

8. The stripper plate sensing system of claim 1, wherein the sensor is a hall effect sensor.

9. The stripper plate sensing system of claim 1, wherein the sensor is a magnetic sensor.

10. A deck plate sensing system, comprising:
(a) a magnet; and
(b) a magnetic sensor,
wherein the magnet and magnetic sensor are configured to measure a distance between the magnet and the magnetic sensor and apply a calibration to measure a relative distance between an adjustable deck plate and a fixed deck plate.

11. The deck plate sensing system of claim 10, wherein the magnet is mounted within a magnet mount, and wherein the magnet mount is affixed to the adjustable deck plate.

12. The deck plate sensing system of claim 11, wherein the magnetic sensor is mounted within an enclosure, and wherein the enclosure is affixed to a bracket attached to a row unit frame.

13. The deck plate sensing system of claim 10, wherein the sensor is in communication with an operations system configured to display and store the relative distance data.

14. The deck plate sensing system of claim 13, wherein the operations system is in communication with a navigation system configured to apply the relative distance data for elimination of cross track error.

15. A deck plate sensing system for a corn harvester, comprising a sensing unit comprising magnetic sensor and a magnet associated with a row unit of the corn harvester, wherein the magnet and magnetic sensor are configured to measure a distance between the magnet and the magnetic sensor, and apply a calibration to measure a relative distance between an adjustable deck plate and a fixed deck plate.

16. The deck plate sensing system of claim 15, wherein the magnet is mounted to the adjustable stripper plate and the magnetic sensor is mounted to a row unit frame.

17. The deck plate sensing system of claim 15, further comprising a sensing unit in association with each row unit of the corn harvester.

18. The deck plate sensing system of claim 17, wherein each magnet is mounted to the adjustable stripper plate and the magnetic sensor is mounted to the row unit frame of its associated row unit.

19. The deck plate sensing system of claim 17, wherein each magnet is mounted to the row unit frame and the magnetic sensor is mounted to the adjustable stripper plate of its associated row unit.

20. The deck plate sensing system of claim 15, wherein the sensing unit is in communication with an operations system configured to display and store the relative distance data.
